(19) United States
(12) Patent Application Publication
(10) Pub. No.: US 2025/0039676 A1
(43) Pub. Date: Jan. 30, 2025

(54) METHOD AND DEVICE FOR REPLACING NETWORK SLICE IN COMMUNICATION SYSTEM

(71) Applicant: Samsung Electronics Co., Ltd., Gyeonggi-do (KR)

(72) Inventors: Dongeun SUH, Gyeonggi-do (KR); Hoyeon LEE, Gyeonggi-do (KR)

(21) Appl. No.: 18/785,751

(22) Filed: Jul. 26, 2024

(30) Foreign Application Priority Data
Jul. 27, 2023 (KR) 10-2023-0098102
Feb. 15, 2024 (KR) 10-2024-0022138

(51) Int. Cl. H04W 16/10; H04W 28/20

(52) U.S. Cl. CPC H04W 16/10; H04W 28/20

(57) ABSTRACT

A method and a device are provided for replacing/changing a network slice in a communication system. A method performed by a network entity in a wireless communication system supporting network slices includes receiving, from an AF, a first message including first information associated with a network slice replacement, and transmitting, based on the first information, to one or more PCFs, a second message including second information associated with the network slice replacement.

### CROSS-REFERENCE TO RELATED APPLICATION(S)

This application is based on and claims priority under 35 U.S.C. § 119 to Korean Patent Application Nos. 10-2023-0098102 and 10-2024-0022138, which were filed in the Korean Intellectual Property Office on Jul. 27, 2023, and Feb. 15, 2024, respectively, the entire disclosure of each of which is incorporated herein by reference.

### BACKGROUND

### 1. Field

The disclosure relates generally to managing a network slice in a communication system, and more particularly, to a method and a device for replacing/changing a network slice in a communication system.

### 2. Description of Related Art

5th generation (5G) mobile communication technology defines a wide frequency band for fast transmission speed and new services and may be implemented in frequencies below 6 gigahertz (GHz) (‘sub 6 GHz’), such as 3.5 GHz, as well as in ultra-high frequency bands (′above 6 GHz′), such as 28 GHz and 39 GHz, which may be referred to as millimeter wave (mmWave). Further, 6th generation (6G) mobile communication technology, which may also be referred to as a beyond 5G system, is expected to be implemented in terahertz (THz) bands (e.g., 95 GHz to 3 THz) to provide transmission speed 50 times faster than 5G mobile communication technology and ultra-low latency reduced by 1/10.

In the early stages of 5G mobile communication technology, standardization was conducted on beamforming and massive multiple input, multiple output (MIMO) for mitigating propagation pathloss and increasing propagation distance in ultrahigh frequency bands, support for various numerologies for efficient use of ultrahigh frequency resources (e.g., operation of multiple subcarrier gaps), dynamic operation of slot formats, initial access technologies for supporting multi-beam transmission and broadband, definition and operation of bandwidth part (BWP), new channel coding, such as a low density parity check (LDPC) code for massive data transmission and a polar code for high-reliable transmission of control information, layer 2 (L2) pre-processing, and network slicing for providing a dedicated network specified for a specific service, in order to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed in consideration of services that 5G mobile communication technology is intended to support. For example, physical layer standardization is underway for technologies, such as vehicle-to-everything (V2X) for increasing user convenience and assisting autonomous vehicles in driving decisions based on the position and state information transmitted from voice over new radio (VoNR), new radio unlicensed (NR-U) aiming at system operations matching various regulatory requirements, new radio (NR) user equipment (UE) power saving, a non-terrestrial network (NTN), which is direct communication between a UE and a satellite to secure coverage in areas where communications with a terrestrial network is difficult, and positioning technology.

Also being standardized are radio interface architecture/protocols for technologies of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step random access channel (RACH) for NR to simplify the random access process, as well as system architecture/service fields for 5G baseline architecture (e.g., a service based architecture or service based interface) for combining network functions virtualization (NFV) and software-defined networking (SDN) technology and mobile edge computing (MEC) for receiving services based on the position of the UE.

As 5G mobile communication systems are commercialized, an increasing number of connected devices will be connected to communication networks such that reinforcement of the function and performance of the 5G mobile communication system and integrated operation of connected devices will likely be needed. To that end, new research is being conducted on various technologies, e.g., extended reality (XR) for efficiently supporting augmented reality (AR), virtual reality (VR), and mixed reality (MR), and 5G performance enhancement and complexity reduction using artificial intelligence (AI) and machine learning (ML), support for AI services, support for metaverse services, and drone communications.

Further, development of such 5G mobile communication systems may be a basis for multi-antenna transmission technology, such as new waveforms for ensuring coverage in 6G mobile communication THz bands, full dimensional MIMO (FD-MIMO), array antennas, and large scale antennas, full duplex technology for enhancing a system network and frequency efficiency of 6G mobile communication technology as well as reconfigurable intelligent surface (RIS), high-dimensional space multiplexing using orbital angular momentum (OAM), metamaterial-based lens and antennas to enhance the coverage of THz band signals, AI-based communication technology for realizing system optimization by embedding end-to-end AI supporting function and using satellite and AI from the design stage, and next-generation distributed computing technology for implementing services with complexity beyond that of the UE operation capability by way of ultrahigh performance communication and computing resources.

### SUMMARY

The disclosure has been made to address at least the above-mentioned problems and/or disadvantages and to provide at least the advantages described below.

An aspect of the disclosure is to provide a method and a device for replacing/changing a network slice in a communication system.

Another aspect of the disclosure is to provide a method and device for replacing/changing a network slice starting from an application function (AF) in a communication system.

Another aspect of the disclosure is to provide a method and device for replacing/changing a network slice in a UE registration procedure or a protocol data unit (PDU) session establishment procedure in a communication system.

Another aspect of the disclosure is to provide a method and device for determining a UE and/or a PDU session in which a network slice is to be replaced in a communication system.

In accordance with an aspect of the disclosure, a method performed by a network entity in a wireless communication system supporting network slices is provided, the method comprises receiving, from an AF, a first message including first information associated with a network slice replacement, and transmitting, based on the first information, to one or more policy control functions (PCFs), a second message including second information associated with the network slice replacement.

In accordance with another aspect of the disclosure, a method performed by an access and mobility management function (AMF) in a wireless communication system supporting network slices is provided, the method comprises receiving, from a PCF, a notification message including information associated with a network slice replacement, determining, based on the received information, the network slice replacement for at least one UE or at least one PDU session, and transmitting, to the at least one UE via a radio access network (RAN), a UE configuration update message including information on at least one alternative network slice to be used in the at least one UE for the network slice replacement.

In accordance with another aspect of the disclosure, a network entity in a wireless communication system supporting network slices is provided, the network entity comprises a transceiver, and a processor configured to receive, from an AF, through the transceiver, a first message including first information associated with a network slice replacement, and transmit, based on the first information, to one or more PCFs through the transceiver, a second message including second information associated with the network slice replacement.

In accordance with another aspect of the disclosure, an AMF in a wireless communication system supporting network slices, the AMF comprises a transceiver, and a processor configured to receive, through the transceiver from a PCF, a notification message including information associated with a network slice replacement, determine, based on the received information, the network slice replacement for at least one UE or at least one PDU session, and transmit, to the at least one UE via a RAN, through the transceiver, a UE configuration update message including information on at least one alternative network slice to be used in the at least one UE for the network slice replacement.

### BRIEF DESCRIPTION OF THE DRAWINGS

The foregoing and other aspects, features, and advantages of certain embodiments of the disclosure will become more apparent from the following description with reference to the accompanying drawings, in which:

FIG. 1 illustrates a network structure for a 5G system, according to an embodiment;

FIG. 2 is a signal flow diagram illustrating a network slice replacement method of an AF-based (initiated) PDU session in a communication system, according to an embodiment;

FIG. 3 is a signal flow diagram illustrating a network slice replacement method based on a network slice replacement target previously stored/identified in an AMF in a UE registration request procedure or a PDU session establishment procedure in a communication system, according to an embodiment; and

FIG. 4 illustrates a network entity in a wireless communication system, according to an embodiment.

### DETAILED DESCRIPTION

Hereinafter, embodiments of the disclosure are described in detail with reference to the accompanying drawings. When determined to make the subject matter of the disclosure unclear, the detailed description of the known art or functions may be skipped.

The terms as used herein are defined considering the functions in the disclosure and may be replaced with other terms according to the intention or practice of the user or operator. Therefore, the terms should be defined based on the overall disclosure.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims.

The same reference numeral denotes the same element throughout the specification.

Blocks in each flowchart and combinations of the flowcharts may be performed by computer program instructions.

Further, each block may represent a module, segment, or part of a code including one or more executable instructions for executing a specified logical function(s). Further, in some replacement embodiments, the functions mentioned in the blocks may occur in different orders. For example, two blocks that are consecutively shown may be performed substantially simultaneously or in a reverse order depending on corresponding functions.

As used herein, the term “unit” may refer to a software element or a hardware element such as a field-programmable gate array (FPGA) or an application specific integrated circuit (ASIC). However, the term ‘unit’ is not limited to software or hardware.

A ‘unit’ may be configured in a storage medium that may be addressed or may be configured to execute one or more processors. For example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments, a “ . . . unit” may include one or more processors.

As used herein, each of such phrases as “A or B”, “at least one of A and B”, “at least one of A or B”, “A, B, or C”, “at least one of A, B, and C”, and “at least one of A, B, or C” may include all possible combinations of the items enumerated together in a corresponding one of the phrases. As used herein, such terms as “1st” and “2nd” or “first” and “second” may be used to simply distinguish a corresponding component from another, and does not limit the components in other aspect (e.g., importance or order).

As used herein, terms for identifying access nodes, terms denoting network entities, terms denoting messages, terms denoting inter-network entity interfaces, and terms denoting various pieces of identification information are provided as an example for ease of description. Thus, the disclosure is not limited by the specific terminology, and such terms may be replaced with other terms denoting objects with equivalent technical concept.

For ease of description, the terms and names defined in the 3rd generation partnership project (3GPP) 5G and NR standards are used herein. However, the disclosure is not limited by such terms and names and may be likewise applicable to various wireless communication systems conforming to other standards. In particular, the disclosure may be applied to 3GPP GS/NR (5th generation mobile communication standards).

A base station may be an entity allocating resource to a terminal and may be at least one of an eNodeB, a Node B, a RAN, an access network (AN), a RAN node, a wireless access unit, a base station controller, or a node over network. A terminal may be at least one of a UE, a mobile station (MS), a cellular phone, a smartphone, a computer, or a multimedia device capable of performing communication functions.

In the disclosure, a downlink (DL) refers to a wireless transmission path of signal transmitted from a base station to a terminal, and an uplink (UL) refers to a wireless transmission path of signal transmitted from the terminal to the base station.

Although a long term evolution (LTE) or LTE advanced (LTE-A) system may be described in connection with embodiments of the disclosure, as an example, the embodiments of the disclosure may also apply to other communication systems with similar technical background or channel form. Further, embodiments of the disclosure may be modified in such a range as not to significantly depart from the scope of the disclosure under the determination by one of ordinary skill in the art and such modifications may be applicable to other communication systems.

The 3GPP, which is in charge of cellular mobile communication standardization, has named a new core network (CN) structure as 5G core (5GC) and standardized the same to promote the evolution from a legacy 4th generation (4G) LTE system to the 5G system. Herein, the terms “5GC” and “5G CN” may be used interchangeably.

A 5GC supports the following differentiated functions as compared to the evolved packet core (EPC), which is the legacy network core for 4G.

A 5GC adopts the network slicing function. As a requirement of the 5G system, 5GC may support various types of terminals and services, e.g., eMBB, URLLC, or mMTC. The terminals/services have different requirements for the CN. For example, the eMBB service requires a high data rate while the URLLC service requires high stability and low latency. Network slice (or also referred to as network slicing) is technology proposed to meet such various requirements.

The 5G mobile communication network includes a 5G UE, a 5G RAN, and a 5G CN. The 5G CN includes network functions (NFs), such as the AMF that provides a mobility management function of the UE, a session management function (SMF) that provides session management functionality, a user plane function (UPF) that performs a data transfer role, a PCF that provides policy control functionality, a unified data management (UDM) that provides data management functions, such as for subscriber data and policy control data, and a unified data repository (UDR) that stores various NFs.

In a 5G system, network slicing is a technique and structure that provides several virtualized, independent, logical networks in one physical network. A network operator may configure a virtual end-to-end network called a network slice and provide services to meet specified requirements for the service/application. The network slice may be identified by an identifier called a single-network slice selection assistance information (S-NSSAI), and the network operator provides the network slice(s), to the UE, to receive a service.

Specifically, in a 5G system, when a UE registers in the network, the UE transmits, to the AMF, identifier information (i.e., requested S-NSSAIs) about the network slice(s) to be requested, and the AMF provides, to the UE, information (allowed network slice selection assistance information (NSSAI)) about the network slice(s) usable by the UE considering the requested S-NSSAIs and subscriber information. Even if the UE does not provide the information about the network slice(s) requested by the UE, the AMF may provide the UE with the allowed NSSAI. In this case, the allowed NSSAI may include information about the network slice(s) set as default (i.e., default subscribed S-NSSAIs) among information about default configuration slice(s) (default configured NSSAI) and subscription network slice(s) included in the UE subscriber information. When determining the allowed NSSAI of the UE, the subscription slice information (subscribed NSSAI) of the corresponding UE and network slice information (e.g., supported S-NSSAIs for tracking area (TA)) supported in the base station where the UE is connected may be considered.

Further, when determining the allowed NSSAI of the UE, an admission control (e.g., a network slice admission control (NSAC)) procedure and an authentication (e.g., a network slice-specific authentication and authorization (NSSAA)) procedure for the corresponding network slice may be performed.

In the NSAC procedure, the AMF transmits, to the NSAC function (NSAC), an update request (e.g., to increase or decrease the number of slice registered UEs) for the number of registered UEs per network slice of the network slice(s), which is the NSAC target among the network slice(s) requested for access by the UE. The network slice that reaches the maximum number of registered UEs may not be allowed to be registered (e.g., not included in the allowed NSSAI).

In the NSSAA procedure, the UE performs authentication on the network slice(s) which is the NSAA target among the network slice(s) requested for access by the UE through the NSAA function (NSAAF). The network slice failing in authentication may not be allowed to be registered (e.g., not included in the allowed NSSAI).

When no network slice may be included in the allowed NSSAI (e.g., when the default configured NSSAI and default subscribed S-NSSAIs are absent or unavailable), the AMF transmits, to the UE, a network registration reject message including the cause code indicating that registration is rejected due to lack of an available network slice.

If a network connection request for traffic transmission is generated in an entity (e.g., the modem, operating system (OS), or application) in the UE, when there is configuration stored (e.g., UE route selection rule or local configuration), the UE may determine which S-NSSAI (and data network name (DNN)) to use by utilizing the rule(s) in the corresponding configuration information matching the traffic information of the corresponding request transmitted from the UE (or the entity in the UE). In this case, the UE may use one of the established PDU sessions as the corresponding S-NSSAI for the matching S-NSSAI or transmit a new PDU session establishment request for the matching S-NSSAI. Thus, traffic transmission/reception is performed through the PDU session associated with a network slice appropriate for the corresponding traffic.

When a network context (e.g., congestion level of network slice), generation of an incorrectly configured network slice (e.g., a context in which it is required to change an incorrectly selected network slice into an appropriate network slice), operator's requirements, third party's requirements (e.g., when the application service provider has upgraded general application user(s) to the premium application user(s), a change of the network slice for the corresponding user(s) to the premium slice, a change of network slice aiming to distribute network slice loads, or a change of network slice to resolve network slice performance deterioration) is newly generated or changed, it is required to select the network slice (or network slice of PDU session) for traffic considering the same.

When a conventional scheme using the above-described UE configuration information (hereinafter, “UE configuration information scheme”) is used, the following issues may arise.

First, the UE configuration information should be updated whenever the foregoing occasion occurs (e.g., generation or change of a requirement). Further, the conventional UE configuration information scheme may operate only when the entity in the UE or the UE provides traffic information (e.g., traffic description) that may match the UE configuration information (e.g., URSP rule).

Therefore, in accordance with an embodiment of the disclosure, a method is provide to address these issues. Specifically, a method is provided for using a PDU session associated with an appropriate network slice per traffic based on network and a method is provided for establishing an appropriate PDU session associated with an appropriate network slice per traffic based on network.

For example, network slice selection information may be provided through a message transmitted from an AF to a PCF or a network slice selection function (NSSF), or it may be requested to replace the network slice with a specific network slice for specific traffic that the UE has already been served. The PCF or NSSF may perform procedures with the AMF for replacing the network slice (e.g., network slice replacement) based on information included in the message received from the AF. Herein, replacement of network slice may be referred to by various terms, such as changing, replacing, or modification of network slice.

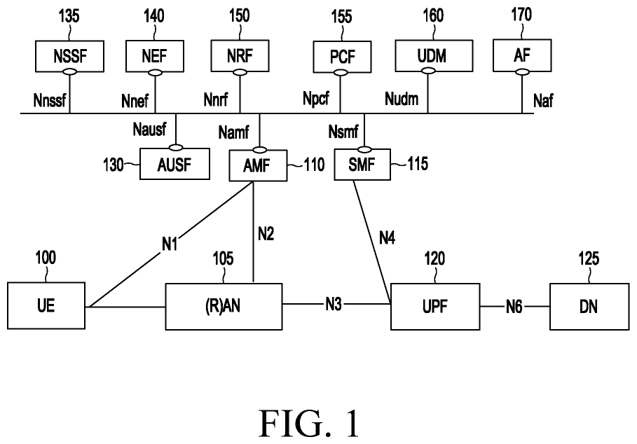

Herein, the network technology may refer to the standards defined by the international telecommunication union (ITU) or 3GPP (e.g., TS 23.501, TS 23.502, TS 23.503, etc.), and each of the components included in the network architecture of FIG. 1 may represent a physical entity or software that performs an individual function or hardware combined with software.

In the drawings, reference numerals shown as N1, N2, N3, . . . , Nxxx indicate known interfaces between the NFs in the 5G CN.

FIG. 1 illustrates a network structure for a 5G system, according to an embodiment.

Referring to FIG. 1, the 5G system includes a 5GC, a base station (e.g., a RAN) 105 and a UE 100. The 5GC includes an AMF 110 for managing mobility of the UE 100, an SMF 115 for managing the session, a UPF 120 connected to a data network (DN) 125 to perform a data transfer function, an NSSF 135 for selecting a network slice serving the UE 100, an authentication server function (AUSF) 130 for authenticating network entity(s) in the 5G system, a network exposure function (NEF) 140 for transmitting or receiving an event occurring in the 5G system and a supporting capability to the outside, a network repository function (NRF) 150 for managing registration information about the NFs, a PCF 155 for providing policy control functionality of the network operator, and a UDM 160 for providing a data management function such as of subscriber data and policy control data, and an AF 170 that provides an application service may communicate with the 5GC.

The AMF 110 is an entity for managing access and mobility of the UE 100. For example, the AMF 110 may perform functions related to registration of the UE 100, connection, reachability, mobility management, access identification/authentication, and mobility event generation.

The SMF 115 may perform a management function for a PDU session of the UE 101. For example, the SMF 115 may perform NFs such as session management functions for establishing, modifying, or releasing a session and maintaining a tunnel between the UPF 120 and the base station 105, the functions for allocating and managing an Internet protocol (IP) address of the UE 100, and selection and control of the user plane.

The UPF 120 may perform a data processing function for transferring data transmitted by the UE 100 to the DN 125, which is an external network, or transferring data received from the DN 125 to the UE 100. Further, the UPF 120 may perform NFs, such as acting as an anchor between radio access technologies (RATs), providing connection with PDU sessions and the AF 170, packet routing and forwarding, packet inspection, application of user plane policy, creating a traffic usage report, or buffering.

The PCF 155 may manage operator policy information for providing the service in the 5G system, and the UDM 160 may perform functions such as generating authentication information for 3GPP security, managing the list of NFs supporting the UE 100, and managing subscription information.

Further, the 5G system may support a technology called session and service continuity (SSC) mode that supports session continuity for the purpose of improving quality-of-experience (QoE) of users or supporting mission critical services.

When the UE 100 registers with a network, the UE 100 may transmit, to the AMF 110, identification information (i.e., requested S-NSSAIs) about network slices to be requested, and the AMF 110 may provide the UE 100 with information (i.e., allowed NSSAI) about network slices usable by the UE 100 in consideration of the requested S-NSSAIs and subscriber information. In order to transmit and receive data to and from a specific DN 125 through allowed network slices (allowed NSSAIs), the UE 100 may select one of the allowed network slices, request the DNN for the network slice to generate a PDU session, and transmit and receive data through the generated PDU session.

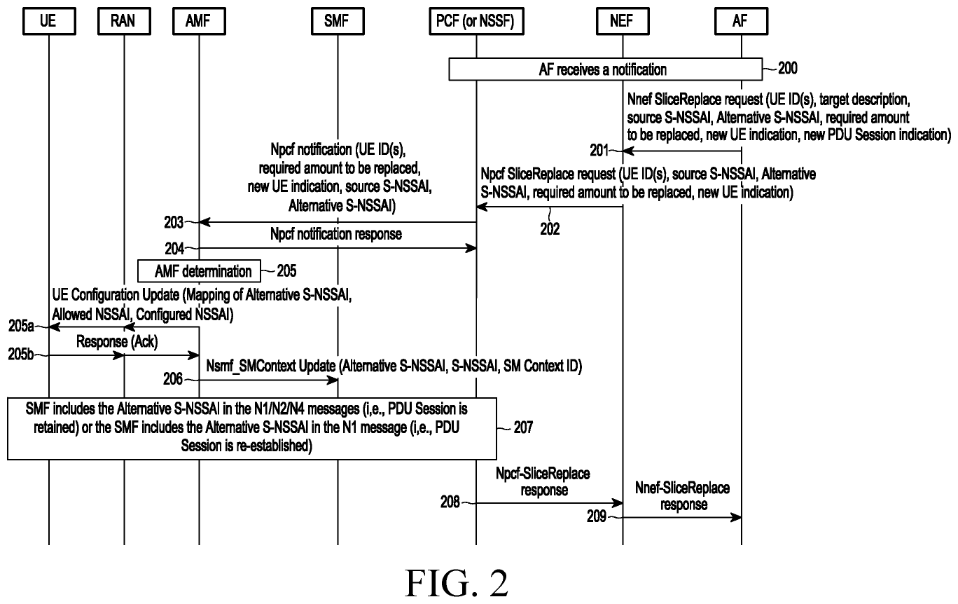

FIG. 2 is a signal flow diagram illustrating a network slice replacement method of an AF-based (initiated) PDU session in a communication system, according to an embodiment;

Referring to FIG. 2, in step 200, a PCF (or NSSF), or an operations, administration and maintenance (OAM) (not shown) for operating, maintaining, or managing the network, when unavailable or congested S-NSSAI(s) occur, transmits a notification message including information including an unavailable S-NSSAI(s) or congested S-NSSAI(s) associated with a corresponding AF, to an AF associated with the S-NSSAI(s), through an NEF.

When receiving the notification message including the unavailable or congested S-NSSAI(s) information from the PCF, NSSF, or OAM, the NEF may figure out/identify an application identifier (App ID) corresponding to the unavailable or congested S-NSSAI(s) based on the configuration information and may transmit the App ID (e.g., an AF-Service-Identifier or an External Application Identifier) instead of the S-NSSAI(s) to the AF(s) corresponding to the corresponding App ID. The configuration information may be, e.g., mapping information between the S-NSSAI(s) and the App IDs.

The notification message in step 200 may include the App ID corresponding to the S-NSSAI(s) together with the unavailable or congested S-NSSAI(s).

In step 201, the AF transmits, to the NEF, a request message (Nnef SliceReplace request) for network slice replacement.

For example, the context in which the request message for network slice replacement is transmitted may include: 1) when the AF receives an App ID using the unavailable network slice information or unavailable network slice in step 200, or 2) when the AF receives the mapping information between the App ID and the network slice in step 200 and desires to change the corresponding mapping.

The request message for network slice replacement in step 201 may include at least one of 1-1) to 1-8) as follows.
1-1) UE identifiers (IDs): UE ID(s) or group ID(s) to which slice replacement request is to be applied. When a group ID is included, the NEF may obtain the UE IDs for each group ID through the UDM.
1-2) Target description: information indicating a target to which a slice replacement request is to be applied. For example, a combination of DNN and S-NSSAI, an AF-Service-Identifier (e.g., an identifier indicating a service of AF), or an External Application Identifier (e.g., an external application identifier) may be included.

When the combination of DNN and the S-NSSAI is not included, the NEF may identify the DNN and the S-NSSAI corresponding to the AF-Service Identifier or the External Application Identifier based on the configuration information.
1-3) source S-NSSAI: identifier information about a network slice desired to be replaced. If the S-NSSAI may be inferred by the target description, it may be omitted.
1-4) Alternative S-NSSAI: alternative slice identifier information for replacing the source S-NSSAI or the S-NSSAI inferable from the target description. For example, when it is desired to replace the S-NSSAI of the PDU session(s) corresponding to the UE ID(s) and the target description with the Alternative S-NSSAI, the Alternative S-NSSAI may be included.
1-5) required amount to be replaced: The number of PDU session(s) (or UEs) to which slice replacement is to be applied and/or the percentage (or proportion) of PDU session(s) (or UEs) to which slice replacement is to be applied. For example, in the case of 100%, all PDU sessions or UEs corresponding to target description and/or UE ID(s) are to be applied. The corresponding information may indicate the number of PDU sessions (or UEs) in the source S-NSSAI in which slice replacement is required to resolve congestion when the AF requests movement due to congestion for the source S-NSSAI.
1-6) new UE indication: when the UE corresponding to the UE ID(s) transmits a request message for first registering the S-NSSAI corresponding to the target description in the future or when application of slice replacement to the corresponding UE is requested.
1-7) new PDU Session indication: when the UE corresponding to the UE ID(s) transmits a PDU session establishment request for the S-NSSAI corresponding to the target description in the future or when application of slice replacement to the corresponding UE is requested as well.
1-8) target slice requirement: information indicating the requirements for the network slice to be changed/replaced. The corresponding information may include slice service type (SST) information (e.g., enhanced eMBB, URLLC, mMTC, etc.), throughput requirement information, latency requirement information, frequency band information, etc.

The NEF obtains the addresses of the corresponding UE(s) or the PCF(s) responsible for the PDU session(s) based on the UE ID(s) included in the request message (Nnef SliceReplace request) for replacing the network slice or the UE ID(s) corresponding to the target description. In this case, the NEF may obtain the address of the corresponding PCF(s) through a binding support function (BSF).

When there are multiple corresponding PCFs, the NEF may determine “required amount to be replaced” information (hereinafter, second replacement amount information) included in the message transmitted to each PCF based on the number or percentage of the PDU session(s) (or UEs) included in the “required amount to be replaced” information (hereinafter, first replacement amount information) received in step 201.

In this case, the number or percentage of the PDU session(s) (or UEs) included in the second replacement amount information (i.e., required amount to be replaced) for each PCF(s) may be determined so that the sum of the numbers or percentages of the PDU session(s) (or UEs) of the second replacement amount information (required amount to be replaced) included in the message(s) transmitted to all the PCF(s) becomes the sum of the numbers or percentages of the PDU session(s) (or UEs) included in the first replacement amount information (required amount to be replaced) received by the NEF in step 201.

In step 202, the NEF transmits, to the corresponding PCF(s), a request message (Npcf SliceReplace request) including at least one of UE ID(s), source S-NSSAI, alternative S-NSSAI, required amount to be replaced, new UE indication, and target slice requirement information, based on the information received from the AF. The NEF may obtain the PCF address (e.g., the PCF ID, the fully qualified domain name (FQDN), the PCF address, etc.) for transmitting the request message through the BSF.

For the definition of the information(s) included in the request message (Npcf SliceReplace request), the definition of the information(s) included in the request message (Nnef SliceReplace request) in step 201 may be referred to.

In step 203, the PCF (or NSSF) transmits a (notification) message (e.g., Npcf Notification or Npcf_AMPolicyAuthorization_Create or Update) including at least one of UE ID(s), required amount to be replaced, new UE indication, source S-NSSAI, alternative S-NSSAI, and DNN information to the AMF, based on the request message received in step 202.

When the target slice requirement is included in the request message received from the NEF in step 202, the PCF may determine an alternative S-NSSAI meeting the target slice requirement and then include the same in the (notification) message transmitted to the AMF in step 203.

Alternatively, the PCF (or NSSF) may transmit an (update) message (e.g., Npcf_PolicyAuthorization_Create or Update) including at least one of UE ID(s), required amount to be replaced, new UE indication, source S-NSSAI, alternative S-NSSAI, and DNN information to the SMF responsible for the corresponding PDU session, based on the request message received in step 202. In this case, at least one of PDU session retained required information and time information may be additionally included.

When the target slice requirement is included in the request message received from the NEF in step 202, the PCF may determine an alternative S-NSSAI meeting the target slice requirement and then may include the same in the (update) message transmitted to the SMF.

For the definition of the information(s) included in the (notification) message (Npcf Notification) in step 203, the definition of the information(s) included in the request message (Nnef SliceReplace request) in step 201 may be referred to.

In step 204, the AMF (or SMF) transmits a response message (Npcf Notification response or Npcf_PolicyAuthorization_Create response or Update response) to the PCF. The corresponding response message may include a processing result (success or failure) of the message received in step 203.

In step 205, when the (notification) message received from the PCF in step 203 includes the source S-NSSAI and the alternative S-NSSAI, the AMF determines whether to replace any of PDU session(s) corresponding to the source S-NSSAI with the alternative S-NSSAI.

When the second replacement amount information (required amount to be replaced) (e.g., the number or percentage of UEs or the number or percentage of PDU sessions) is included in the (notification) message received, by the AMF, from the PCF, in step 203, the AMF may determine the number of UEs or the number of PDU sessions to be replaced based on the second replacement amount information, and may determine the UEs or PDU sessions to be replaced.

For example, when the second replacement amount information (required amount to be replaced) includes information indicating 30% UEs (or PDU sessions), the AMF may determine network slice replacement for 30% of the UEs (or PDU sessions associated with the corresponding S-NSSAI) among UEs (or PDU sessions) registered in the source S-NSSAI.

As another example, when the second replacement amount information (required amount to be replaced) includes information indicating a specific number of UEs, e.g., 300 UEs, (or PDU sessions), network slice replacement for 300 UEs (or PDU sessions associated with the corresponding S-NSSAI) among UEs (or PDU sessions) registered in the source S-NSSAI may be determined.

In step 205a, the AMF transmits, to the corresponding UE, via the RAN, a UE configuration update (UCU) message including at least one of 2-1) to 2-3) as described below, for the UE(s) determined to replace the network slice in step 205.
2-1) Mapping of Alternative S-NSSAI: information indicating that Source S-NSSAI is mapped to Alternative S-NSSAI (i.e., Alternative S-NSSAI is used instead of Source S-NSSAI).
2-2) Allowed NSSAI: if the Alternative S-NSSAI is not included in the Allowed NSSAI, an Allowed NSSAI including the Alternative S-NSSAI is included.
2-3) Configured NSSAI: if the Alternative S-NSSAI is not included in the Configured NSSAI, the Configured NSSAI including the Alternative S-NSSAI is included.

In step 205b, the UE transmits a response message, to the AMF, through the RAN, which may include ack information indicating that the UE has successfully received the UCU message.

In step 206, when determining the UE(s) to perform network slice replacement in step 205, the AMF transmits, to the SMF responsible for the PDU session associated with the source S-NSSAI for each UE, an update message (Nsmf_SMContext Update) including at least one of 3-1) to 3-3) as described below.

Alternatively, when the AMF determines the PDU session(s) for performing network slice replacement in step 205, the AMF transmits, to the SMF responsible for each PDU session, an update message Nsmf_SMContext Update including at least one of 3-1) to 3-3).
3-1) Alternative S-NSSAI: indicates the S-NSSAI to be newly used for the PDU session.
3-2) S-NSSAI: indicates the existing S-NSSAI of the PDU session.
3-3) SM Context ID: indicates the SM Context ID for the PDU session.

In step 207, the SMF performs network slice replacement based on information included in the update message (Nsmf_SMContext Update).

Although steps 203 to 206 described above exemplify a case in which network slice replacement is performed through the AMF, network slice replacement may also be performed through the SMF. In this case, steps 203 to 206 may be omitted.

Although not specifically illustrated in FIG. 2, in step 207, the SMF may receive the message (e.g., Npcf_PolicyAuthorization_Create or Update) described in step 203, from the PCF, and, if network slice replacement is possible, the SMF may perform network slice replacement based on the information (e.g., at least one of UE ID(s), required amount to be replaced, new UE indication, source S-NSSAI, alternative S-NSSAI, or DNN) included in the message. For example, the SMF may perform network slice replacement with the alternative S-NSSAI included in the message (e.g., Npcf_PolicyAuthorization_Create or Update) described in step 203 for the target PDU session.

Alternatively, when the alternative S-NSSAI is not included in the message in step 203, but the S-NSSAI is included, the SMF may replace the network slice of the PDU session from the alternative S-NSSAI to the existing S-NSSAI. When time information is included in the message in step 203, the SMF may perform network slice replacement according to the corresponding time information. For example, when the start time and the end time are included in the time information, the SMF may perform network slice replacement at the corresponding start time and may end at the end time. If the PDU session retained required information is included in the message in step 203, when the SMF is unable to maintain the PDU session (i.e., when failing to replace the network slice while maintaining the PDU session), the SMF may include a result indicating the failure in the response message (e.g., the response message to the message (Npcf_PolicyAuthorization_Create or Update)) described in step 204 and transmit the same to the PCF (or NSSF). The SMF, when determining to maintain the PDU session, may include identifier information (in the case of N4 message, N4 session identifier information) indicating the PDU session and the alternative S-NSSAI in the N1/N2/N4 message transmitted to the UE, RAN, or UPF.

When the SMF determines to newly establish a PDU session, the SMF may include at least one of the PDU session modification command, cause, or alternative S-NSSAI in the N1 message transmitted to the UE and transmit the same. In this case, the cause may include information indicating that the UE should perform a PDU session reestablishment request.

In step 208, the PCF (or NSSF) may transmit, to the NEF, a response message (Npcf SliceReplace response) to the request message received in step 201.

In step 209, when the NEF receives the corresponding response message from the PCF (or NSSF), the NEF transmits, to the AF, the response message (Nnef SliceReplace response) to the request message in step 202.

The corresponding response message may include the following information.
result per UE (or app): When the UE ID(s) is included in the request message in steps 201 and 202, a network slice replacement processing result (success or failure) for each UE ID is included. If the network slice replacement is successful, an alternative S-NSSAI for the corresponding UE ID may be included. For example, the Alternative S-NSSAI may be included when the PCF, the NSSF, or the AMF determines the Alternative S-NSSAI (e.g., the case where only the S-NSSAI is included and the Alternative S-NSSAI is not included in step 201 or only information for inferring the S-NSSAI (e.g., an AF-Service-Identifier or an External App Identifier) is included).

When the request message in steps 201 and 202 includes an external application identifier or an AF-Service identifier, a result (success or failure) of network slice replacement processing together with the corresponding identifier may be included in the response message in steps 208 and 209.

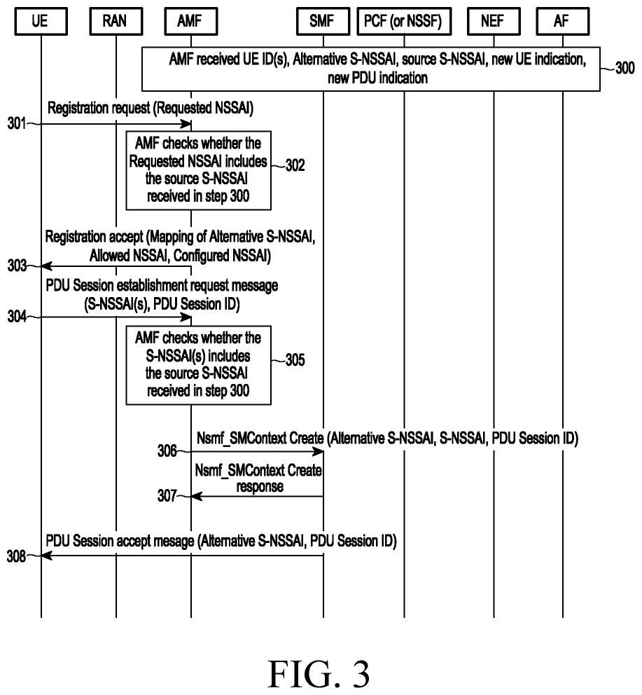

FIG. 3 is a signal flow diagram illustrating a network slice replacement method based on a network slice replacement target previously stored/identified in an AMF in a UE registration request procedure or a PDU session establishment procedure in a communication system, according to an embodiment.

Referring to FIG. 3, in step 300, the AMF receives, from a PCF (or an NSSF), and stores a message including at least one of 4-1) to 4-6) information, as described below.
4-1) UE ID(s): UE ID(s) or group ID(s) to which slice replacement request is to be applied. When a group ID is included, the NEF may obtain the UE IDs for the group ID through the UDM.
4-2) source S-NSSAI: identifier information about a slice desired to be replaced. If the S-NSSAI may be inferred by the target description, it may be omitted.
4-3) Alternative S-NSSAI: alternative network slice identifier information to replace the source S-NSSAI or the S-NSSAI inferable from the target description. For example, when it is desired to replace the S-NSSAI of the PDU sessions corresponding to the UE ID(s) and the target description with the Alternative S-NSSAI, the Alternative S-NSSAI may be included.
4-4) required amount to be replaced: the number of PDU sessions (or UEs) to which slice replacement is to be applied or the percentage (or proportion) of PDU sessions (or UEs) to which slice replacement is to be applied (e.g., in the case of 100%, all PDU sessions or UEs corresponding to the target description and/or UE IE(s) are applied). The corresponding information may indicate the number of PDU sessions (or UEs) in the source S-NSSAI in which replacement is required to resolve congestion when the AF requests movement due to congestion for the source S-NSSAI.
4-5) new UE indication: when the UE corresponding to the UE ID(s) transmits the request message for first registering the S-NSSAI corresponding to the target description or source S-NSSAI and the case where the UE requests to apply slice replacement.
4-6) new PDU Session indication: when the UE corresponding to the UE ID(s) transmits a PDU session establishment request for the S-NSSAI corresponding to the target description in the future or when application of slice replacement to the corresponding UE is requested as well.

The AMF may determine UE(s) to which network slice replacement is to be applied based on the message received in step 300. If the new UE indication is included in the received message, the AMF may determine, as a network slice replacement target, not only the currently registered UE(s) but also the UE(s) requesting registration from the source S-NSSAI in the future.

The AMF may determine PDU session(s) to which network slice replacement is to be applied based on the message received in step 300. If the received message includes a new PDU session indication, the AMF may determine a new PDU session establishment request to the source S-NSSAI in addition to the currently established PDU session as a network slice replacement target.

The AMF may pre-store/identify information about the network slice replacement target. For example, at least one of UE ID(s), source S-NSSAI, alternative S-NSSAI, new UE indication, or new PDU session indication included in the message received in step 300 may be stored/identified in advance for a network slice replacement procedure to be performed in the future.

When the AMF determines to apply network slice replacement to all UE(s) for the source S-NSSAI, it may store/identify at least one of the source S-NSSAI(s), the alternative S-NSSAI(s), the new UE indication, or the new PDU session indication.

In step 301, the AMF receives, from a UE, a registration request message including the requested NSSAI, in the registration procedure of the UE.

In step 302, the AMF identifies whether the source S-NSSAI, which is the target of the network slice replacement stored in step 300, is included among the S-NSSAI(s) included in the requested NSSAI(s) included in the registration request message received from the UE. Further, the AMF identifies whether the new UE indication is included in the message received in step 300.

When the source S-NSSAI is included in the requested NSSAI(s) in the registration request message and the new UE indication is included in the message received in step 300, the AMF may perform network slice replacement on the corresponding UE. In this case, the AMF may determine the alternative S-NSSAI based on the information stored/identified in step 300.

In step 303, the AMF transmits a registration accept message to the UE.

When the AMF determines to replace the network slice with the alternative S-NSSAI(s) for at least one of the S-NSSAIs included in the requested NSSAI(s) in the registration request message transmitted by the UE in step 301, at least one of information 5-1) to 5-3), as described below, may be included for each corresponding S-NSSAI (i.e., the Source S-NSSAI):
5-1) Mapping of Alternative S-NSSAI: information indicating that Source S-NSSAI is mapped to Alternative S-NSSAI (i.e., Alternative S-NSSAI is used instead of Source S-NSSAI).
5-2) Allowed NSSAI: if the Alternative S-NSSAI is not included in the Allowed NSSAI, the Allowed NSSAI including the Alternative S-NSSAI is included.
5-3) Configured NSSAI: if the Alternative S-NSSAI is not included in the Configured NSSAI, the Configured NSSAI including the Alternative S-NSSAI is included.

In step 304, the AMF receives, from the UE, a PDU session establishment request message, in the PDU session establishment procedure of the UE. The request message of step 304 may include an S-NSSAI(s) and a PDU session ID.

In step 305, the AMF identifies whether the S-NSSAI included in the request message received from the UE in step 304 is included in the source S-NSSAI(s) which is the network slice replacement target. When the S-NSSAI included in the request message is included in the source S-NSSAI(s), the AMF may perform network slice replacement on the PDU session establishment request. In this case, the AMF may determine an alternative S-NSSAI based on previously stored information.

In step 306, the AMF selects the SMF for managing the PDU session of the UE based on the Alternative S-NSSAI determined in step 305, and transmits a message (Nsmf_SMContext Create) to the selected SMF. In step 306, the AMF may include the alternative S-NSSAI and the S-NSSAI and the PDU session ID received from the UE in step 304 in the message (Nsmf_SMContext Create) transmitted to the selected SMF.

In step 307, the SMF transmits, to the AMF, a response message to the received message (Nsmf_SMContext Create).

In step 308, the SMF includes the alternative S-NSSAI and the PDU session ID in a message (PDU session accept message) transmitted to the UE, via the AMF and the RAN, to accept establishment of the PDU session.

In the example of FIG. 3, steps 301 to 303 for network slice replacement in the registration procedure of the UE and steps 304 to 308 for network slice replacement in the PDU session establishment procedure of the UE have been illustrated and described together for convenience of description, but steps 301 to 303 and steps 304 to 308 may also be performed as individual embodiments.

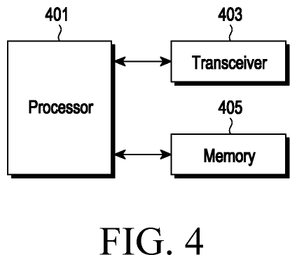

FIG. 4 illustrates a network entity in a wireless communication system according to an embodiment.

Referring to FIG. 4, the network entity may a UE, an AMF, an SMF, a PCF (or an NSSF), an NEF, or an AF described above in connection with FIGS. 1 to 3.

The network entity includes a processor 401, a transceiver 403, and memory 405. The processor 401, transceiver 403, and memory 405 may be operated according to the communication methods of the network entities described above in connection with FIGS. 1 to 3.

However, the components of the network entity are not limited to those illustrated in FIG. 4. For example, the network entity may include more or fewer components than the above-described components.

The processor 401, the transceiver 403, and the memory 405 may be implemented in the form of a single chip.

The transceiver 403 collectively refers to a receiver of the network entity and a transmitter of the network entity and may transmit and receive signals to/from a UE or another network entity. The transmitted/received signals may include at least one of control information and data. To that end, the transceiver 403 may include a wired/wireless transceiver and may include various components for transmitting/receiving signals. The transceiver 403 may receive signals through a predetermined communication interface, output the signals to the processor 401, and transmit the signals output from the processor 401.

Further, when the network entity of FIG. 4 is a UE, the transceiver 403 may include a radio frequency (RF) transmitter for frequency-up converting and amplifying signals transmitted and an RF receiver for low-noise amplifying signals received and frequency-down converting the frequency of the received signals. Further, the transceiver 403 may receive the communication signal and output it to the processor 401 and transmit the signal output from the processor 401 to the UE or another network entity through the network.

The memory 405 may store programs and data necessary for the operation of the network entity according to at least one of the embodiments of FIGS. 1 to 3. Further, the memory 405 may store control information or data that is included in the signal obtained by the network entity. The memory 405 may include a storage medium, such as read only memory (ROM), random access memory (RAM), a hard disk, a compact disc ROM (CD-ROM), a digital versatile disc (DVD), or a combination of storage media.

The processor 401 may control a series of processes so that the network entity may operate according to at least one of the embodiments of FIGS. 1 to 3. The processor 401 may include at least one processor.

The methods according to the embodiments described in the specification or claims of the disclosure may be implemented in hardware, software, or a combination of hardware and software. When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, ROMs, electrically erasable programmable ROMs (EEPROMs), magnetic disc storage devices, CD-ROMs, DVDs, or other types of optical storage devices, or magnetic cassettes. The programs may also be stored in memory constituted of a combination of all or some thereof. As each constituting memory, multiple ones may be included. The programs may be stored in attachable storage devices that may be accessed via a communication network, such as the Internet, Intranet, local area network (LAN), wide area network (WAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for case of description, and the disclosure is not limited to singular or plural components. As used herein, the singular forms “a,” “an,” and “the” are intended to include the plural forms as well, unless the context clearly indicates otherwise.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a network entity in a wireless communication system supporting network slices, the method comprising:
receiving, from an application function (AF), a first message including first information associated with a network slice replacement; and
transmitting, based on the first information, to one or more policy control functions (PCFs), a second message including second information associated with the network slice replacement.

2. The method of claim 1, wherein the first information includes at least one of:
identification information of one or more user equipments (UEs) to which the network slice replacement is to be applied;
identification information of a source network slice to be replaced;
identification information of an alternative network slice with which the source network slice is replaced; or
information on first required amount representing at least one of a number of one or more protocol data unit (PDU) sessions and a number of the one or more UEs to which the network slice replacement is to be applied.

3. The method of claim 1, wherein the second information includes at least one of:
identification information of one or more user equipments (UEs) to which the network slice replacement is to be applied;
identification information of a source network slice to be replaced;
identification information of an alternative network slice with which the source network slice is replaced; or
information on second required amount representing at least one of a number of one or more protocol data unit (PDU) sessions and a number of the one or more UEs to which the network slice replacement is to be applied,
wherein the information on the second required amount is determined within a range of information on first required amount received from the AF.

4. The method of claim 1, wherein the network entity includes a network exposure function (NEF), and
wherein the first information further includes information on first required amount representing at least one of a number of one or more protocol data unit (PDU) sessions and a number of the one or more user equipments (UEs) to which the network slice replacement is to be applied,
wherein the second information includes information on second required amount representing at least one of a number of one or more PDU sessions and a number of the one or more UEs to which the network slice replacement is to be applied, and
wherein the NEF determines the information on the second required amount to be provided to each of the one or more PCFs, based on the information on the first required amount.

5. The method of claim 4, wherein the NEF determines the information on the second required amount to be provided to each of the one or more PCFs within a range of the information on the first required amount received from the AF, in case that the one or more PCFs exist plural.

6. A method performed by an access and mobility management function (AMF) in a wireless communication system supporting network slices, the method comprising:
receiving, from a policy control function (PCF), a notification message including information associated with a network slice replacement;
determining, based on the received information, the network slice replacement for at least one user equipment (UE) or at least one protocol data unit (PDU) session; and
transmitting, to the at least one UE via a radio access network (RAN), a UE configuration update message including information on at least one alternative network slice to be used in the at least one UE for the network slice replacement.

7. The method of claim 6, wherein the information on the at least one alternative network slice includes information representing that at least one source network slice for the at least one UE is mapped to at least one alternative network slice.

8. The method of claim 6, wherein the information associated with the network slice replacement includes at least one of:
identification information of the at least one UE to which the network slice replacement is to be applied;
identification information of a source network slice to be replaced;
identification information of an alternative network slice with which the source network slice is replaced; or
information on required amount representing at least one of a number of the at least one PDU session and a number of the at least one UE to which the network slice replacement is to be applied.

9. The method of claim 8, wherein the AMF determines the network slice replacement for the at least one UE, based on the required amount representing the number of the at least one UE among UEs registered in at least one source network slice.

10. The method of claim 8, wherein the AMF determines the network slice replacement for the at least one UE, based on the required amount representing the number of the at least one PDU session among PDU sessions registered in at least one source network slice.

11. A network entity in a wireless communication system supporting network slices, the network entity comprising:
a transceiver; and
a processor configured to:
receive, from an application function (AF), through the transceiver, a first message including first information associated with a network slice replacement, and
transmit, based on the first information, to one or more policy control functions (PCFs) through the transceiver, a second message including second information associated with the network slice replacement.

12. The network entity of claim 11, wherein the first information includes at least one of:
identification information of one or more user equipments (UEs) to which the network slice replacement is to be applied;
identification information of a source network slice to be replaced;
identification information of an alternative network slice with which the source network slice is replaced; or
information on first required amount representing at least one of a number of one or more protocol data unit (PDU) sessions and a number of the one or more UEs to which the network slice replacement is to be applied.

13. The network entity of claim 11, wherein the second information includes at least one of:
identification information of one or more user equipments (UEs) to which the network slice replacement is to be applied;
identification information of a source network slice to be replaced;
identification information of an alternative network slice with which the source network slice is replaced; or
information on second required amount representing at least one of a number of one or more protocol data unit (PDU) sessions and a number of the one or more UEs to which the network slice replacement is to be applied, and
wherein the information on the second required amount is determined within a range of information on first required amount received from the AF.

14. The network entity of claim 11, further comprising a network exposure function (NEF),
wherein the first information includes information on first required amount representing at least one of a number of one or more protocol data unit (PDU) sessions and a number of the one or more UEs to which the network slice replacement is to be applied,
wherein the second information includes information on second required amount representing at least one of a number of one or more PDU sessions and a number of the one or more UEs to which the network slice replacement is to be applied, and
wherein the processor is configured to determine the information on the second required amount to be provided to each of the one or more PCFs, based on the information on the first required amount.

15. The network entity of claim 14, wherein the processor is further configured to determine the information on the second required amount to be provided to each of the one or more PCFs within a range of the information on the first required amount received from the AF, in case that the one or more PCFs exist plural.

16. An access and mobility management function (AMF) in a wireless communication system supporting network slices, the AMF comprising:
a transceiver; and
a processor configured to:
receive, through the transceiver from a policy control function (PCF), a notification message including information associated with a network slice replacement,
determine, based on the received information, the network slice replacement for at least one user equipment (UE) or at least one protocol data unit (PDU) session, and
transmit, to the at least one UE via a radio access network (RAN), through the transceiver, a UE configuration update message including information on at least one alternative network slice to be used in the at least one UE for the network slice replacement.

17. The AMF of claim 16, wherein the information on the at least one alternative network slice includes information representing that at least one source network slice for the at least one UE is mapped to at least one alternative network slice.

18. The AMF of claim 16, wherein the information associated with the network slice replacement includes at least one of:
identification information of the at least one UE to which the network slice replacement is to be applied;
identification information of a source network slice to be replaced;
identification information of an alternative network slice with which the source network slice is replaced; or
information on required amount representing at least one of a number of the at least one protocol data unit (PDU) session and a number of the at least one UE to which the network slice replacement is to be applied.

19. The AMF of claim 18, wherein the processor is further configured to determine the network slice replacement for the at least one UE, based on the required amount representing the number of the at least one UE among UEs registered in at least one source network slice.

20. The AMF of claim 18, wherein the processor is further configured to determine the network slice replacement for the at least one UE, based on the required amount representing the number of the at least one PDU session among PDU sessions registered in at least one source network slice.
